(19) United States
(12) Patent Application Publication
(10) Pub. No.: US 2006/0172638 A1
(43) Pub. Date: Aug. 3, 2006

(54) Textile composite intended for mechanical reinforcement of a bitumen-based waterproof coating

(75) Inventor: Claude Chabal, Saint Martin De Valamas (FR)

Correspondence Address: BURR & BROWN, PO BOX 7068, SYRACUSE, NY, 13261-7068, US

(73) Assignee: Chomarat Composites, Paris (FR)

(21) Appl. No.: 11/319,878

(22) Filed: Dec. 28, 2005

(30) Foreign Application Priority Data
Jan. 28, 2005 (FR) 05.50248

(51) Int. Cl. B32B 5/26; D03D 9/00; B32B 27/12; B32B 11/02

(52) U.S. Cl. 442/36; 442/35; 442/43; 442/45; 442/46; 442/48; 442/20; 442/21

(57) ABSTRACT

A textile composite (1) intended for mechanical reinforcement of a bitumen-based waterproof coating, characterised in that it comprises:
a first layer (7) of a non-woven fabric material based on synthetic fibres that is puncture resistant;
a second layer (6) of a non-woven fabric material based on mineral or synthetic fibres that is fire resistant;
a grid structure (2) placed between the first and second layers (6, 7), the warp yarns (3) and weft yarns (4) of which are connected to each other at the points where they cross by means of an adhesive that also ensures bonding of the first (7) and second (6) layers on the grid (2).

### BACKGROUND OF THE INVENTION

The present invention relates to the field of technical textiles used for manufacturing bitumen-based waterproof coatings in particular. This type of coating generally comprises textile composites for mechanical reinforcement.

The invention relates more especially to a structure for this type of composite which has improved properties in terms of mechanical strength and fire resistance.

### DESCRIPTION OF THE PRIOR ART

Generally speaking, the waterproof coatings used for roofing in particular comprise a bituminous layer which has to be mechanically reinforced because bitumen alone does not have satisfactory mechanical properties.

The use of textile reinforcements inside this type of coating is widely known and disclosed, in particular, in Documents U.S. Pat. No. 3,193,439 and U.S. Pat. No. 3,937,640.

The purpose of these textile reinforcements is firstly to improve the mechanical properties of the coating by increasing its tensile strength.

Another mechanical purpose of the reinforcement is to make the coating puncture resistant in order to preserve the watertightness of the coating. In addition, for many applications, it is desirable for the coating to have fire resistance properties and this leads to the use of special textile composites.

The composites used for these applications therefore generally feature a grid structure which may be based on glass fibre yarns or synthetic yarns that have good tensile strength. This grid is combined with a non-woven fabric type textile layer which is generally based on glass fibres to give fire resistance and based on polyester fibres in order to give puncture resistance. The grid and the non-woven fabric structure are generally joined by needlepunching in order to avoid any delamination problems as described in the Applicant's Patent EP-0,907,781.

Although it is satisfactory in overall terms, this type of reinforcement nevertheless has certain drawbacks. The needlepunching operations are relatively awkward to carry out and also impose constraints in terms of the size of the fibres and the basis weight of the non-woven fabrics used in order to obtain secure attachment to the grid.

In fact, assembly methods that use bonding which might make it possible to overcome the above-mentioned constraints are not really satisfactory from a mechanical point of view. More precisely, if the adhesives used are based on polyvinyl chloride (PVC), the thermofusible nature of the adhesive means that the layer of adhesive softens when it comes into contact with the bitumen of the coating which is often at a temperature of around 180° C. to 200° C. Bonding is therefore adversely affected and the risks of delamination are very considerable. On the other hand, the use of latex-based adhesives (SBR) which have better heat resistance is also known. Nevertheless, these materials are thermosetting and are therefore brittle and, generally speaking, offer less mechanical strength.

The object of the invention is therefore to propose a reinforcement which has excellent mechanical strength properties both in terms of puncture resistance and tensile strength, and also offers very good fire resistance behaviour.

Another object of the invention is to make it possible to produce this type of composite reinforcement using a simple production process which does not increase the cost price of the reinforcement.

### SUMMARY OF THE INVENTION

The invention therefore relates to a textile composite intended for mechanical reinforcement of a waterproof coating, especially a bitumen-based coating.

In accordance with the invention, this composite comprises:

a first layer of a non-woven fabric material based on synthetic fibres that is puncture resistant;

a second layer of a non-woven fabric material based on mineral or synthetic fibres that is fire resistant;

a grid structure placed between the first and second layers, the warp and weft yarns of which are connected to each other at the point where they cross by means of an adhesive which also ensures bonding of the first and second layers on said grid.

In order words, the invention involves producing a composite which combines two non-woven fabric layers, one of which is puncture resistant and the other of which is fire resistant, joining of these two non-woven fabrics being obtained by bonding to a grid structure which itself confers certain tensile strength, dimensional stability and stretch resistance properties. It should be noted that it is the adhesive that ensures cohesion of the warp and weft yarns of the grid which secures the two non-woven fabric layers on each of the surfaces of the grid.

In practice, the non-woven fabric layer having puncture resistance properties can be based on synthetic fibres selected from the group comprising polyester, polyamide and, generally speaking, other fibres that can withstand the temperature of the bitumen. As far as the layer which has fire resistance properties is concerned, glass but also non-woven fabrics based on carbon or aramid fibres can be used as a suitable material.

The yarns that make up the grid can be high-tenacity yarns such as glass fibre, carbon or aramid yarns.

The grid may also be a mixed grid that combines high-tenacity fibres with polyester in order to combine tensile strength, elongation at rupture and dimensional stability properties.

The adhesive used to produce the grid may be latex based and, generally speaking, an adhesive that has heat resistance properties. It should be noted that using a thermosetting material for the adhesive of the grid does not degrade the mechanical properties of the assembly, on the contrary, these are improved by the presence of the puncture-resistant non-woven fabric layer.

The invention therefore also concerns a method of manufacturing this type of composite.

This method involves:

manufacturing a grid by impregnating the warp and weft yarns;

after removal of the grid from the liquid adhesive, applying non-woven fabrics of different types onto each of the surfaces of the grid;

subjecting this assembly to polymerisation so as to ensure bonding of the two non-woven fabrics to the grid by means of the adhesive which ensures cohesion of the various yarns of the grid.

In other words, this method involves producing a composite in a single process by joining the two non-woven fabrics to the grid even before the adhesive that ensures cohesion of the grid has totally polymerised. One might suspect that the use of heterogeneous materials (i.e. the two non-woven fabrics) would result in differential shrinkage effects similar to the effect produced by a bimetallic strip and hence the appearance of surface irregularities. However, it has been observed that by controlling the cross-linking temperatures and the tensions on the machine, producing the composite in a single process by bringing the two non-woven fabrics together simultaneously does not produce any differential shrinkage or lack of flatness.

### BRIEF DESCRIPTION OF THE DRAWINGS

The way in which the invention is implemented and its resulting advantages will become more apparent from the following description of the embodiment given, reference being made to the accompanying drawings:

FIG. 1 is a simplified perspective view of a composite in accordance with the invention shown after partial delamination;

FIG. 2 is a diagram that explains the method that makes it possible to produce the composite in FIG. 1.

### DESCRIPTION OF THE PREFERRED EMBODIMENTS

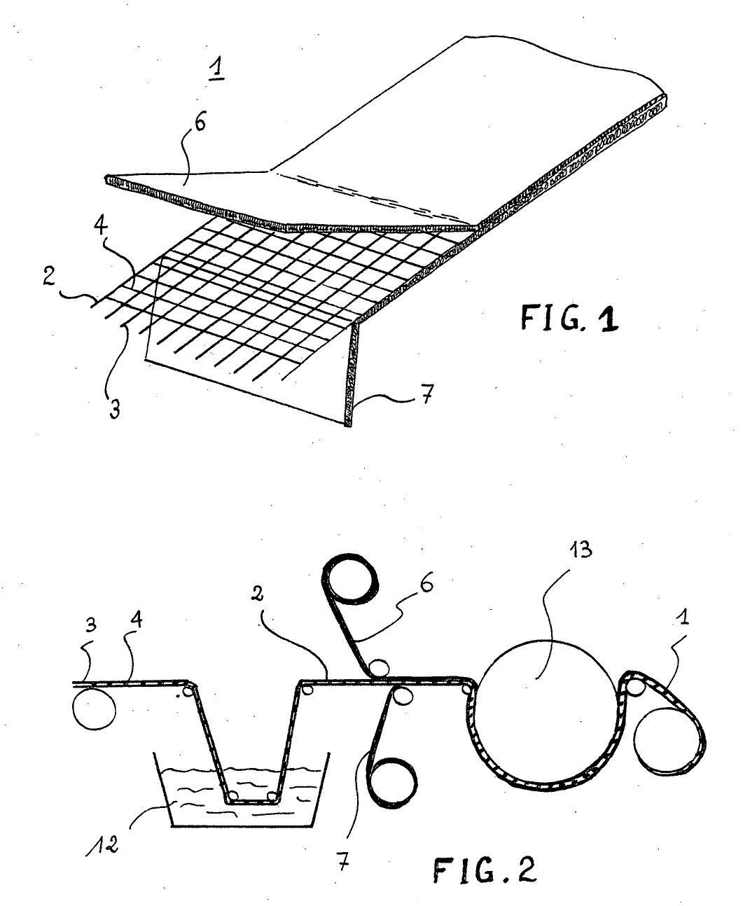

As shown in FIG. 1, the composite (1) comprises three separate layers, namely a grid (2) which has, on each of its surfaces, a non-woven fabric (6, 7). More precisely, the grid (2) consists of warp yarns (3) and weft yarns (4). A grid comprising warp and weft glass fibre yarns of 68 tex with 4 yarns per centimetre and a mesh size of approximately 2 mm can be produced for example. One can also produce a mixed grid having 3 yarns/cm in each direction by combining, per centimetre, 1 glass fibre yarn of 136 tex and 2 polyester yarns of 110 tex with an approximate mesh size of 3 mm.

The non-woven fabric (6) intended to be placed on the upper surface of the waterproof coating is based on glass fibres. More precisely, this non-woven fabric can be based on fibres having a diameter of the order of 9 to 17 μm and a length of 10 to 25 mm. This non-woven fabric has a basis weight of the order of 50 g/m². Good results are obtained by using a non-woven fabric marketed under the part number U50/2 by the firm VETROTEX ST GOBAIN. This non-woven glass fabric (6) makes it possible to give the reinforcement a regular surface appearance which compensates for the irregularities of the grid (2). It also provides fire resistance and dimensional stability.

As already stated, this non-woven fabric (6) can also be based on other fibres which have comparable heat resistance, these including carbon or aramid fibres.

The second non-woven fabric (7) placed on the opposite surface of grid (2) is based on polyester or, for other applications, based on appropriate synthetic fibres such as polyamide. The polyester fibres used are also based on short fibres or continuous filaments (spunbond) in order to give a basis weight in excess of 30 g/m² in order to obtain satisfactory puncture resistance.

The entire composite (1) therefore has a thickness of 0.8 to 1.5 mm. It is obtained, as shown in FIG. 2, by using a one-stage method. More precisely, the grid structure (2) is formed by assembling the warp yarns (3) and the weft yarns (4). This structure is then bonded in the liquid adhesive (12). This liquid adhesive conventionally comprises a butadiene styrene, acrylic or polyvinyl acetate type adhesive. After removal from the liquid adhesive (12), the grid and the adhesive which has not yet polymerised are taken to the station where the two non-woven fabrics (6, 7) are applied. In this way, the adhesive that has not yet polymerised impregnates these two non-woven fabrics. The assembly is then cross-linked by passing it over a heated cylinder (13) in order to ensure total polymerisation of the adhesive. The composite (1) is then wound into rolls for subsequent use.

The above description shows that the composite according to the invention has many advantages, especially the advantage of combining smooth surface appearance, fire resistance and dimensional stability thanks to one of its non-woven fabric layers, with tear strength and puncture resistance thanks to the other layer of the composite. The assembly has good tensile strength thanks to the intermediate grid. The composite also has the advantage of being manufactured in a single stage.

1/ A textile composite (1) intended for mechanical reinforcement of a bitumen or synthetic-material based waterproof coating, characterised in that it comprises:
a first layer (7) of a non-woven fabric material based on synthetic fibres that is puncture resistant;
a second layer (6) of a non-woven fabric material based on mineral or synthetic fibres that is fire resistant;
a grid structure (2) placed between the first and second layers (6, 7), the warp yarns (3) and weft yarns (4) of which are connected to each other at the point where they cross by means of an adhesive which also ensures bonding of the first (7) and second (6) layers on grid (2).

2/ A composite as claimed in claim 1, characterised in that the first layer (7) is based on a heat resistant material, selected, in particular, from a group that includes polyester and polyamide.

3/ A composite as claimed in claim 1, characterised in that the fibres of the second layer (6) are based on a material selected from a group that includes glass, carbon and aramid.

4/ A composite as claimed in claim 1, characterised in that the yarns of the grid (2) are based on a high-tenacity material.

5/ A composite as claimed in claim 4, characterised in that the yarns of the grid (2) are based on a heat resistant material, selected, in particular, from a group that includes glass fibre, carbon, aramid and polyester yarns.

6/ A method for manufacturing a textile composite intended for mechanical reinforcement of a bitumen-based waterproof coating, characterised in that it involves:
manufacturing a grid (2) by bonding the warp yarns (3) and weft yarns (4);
after removal of the grid from the liquid adhesive (12), applying two non-woven fabrics (6, 7) of different type onto each of the surfaces of the grid;
subjecting this assembly (1) to cross-linking (13).
